(19) United States
(12) Patent Application Publication
(10) Pub. No.: US 2013/0114841 A1
(43) Pub. Date: May 9, 2013

(54) EARPHONE IMPORTING OUTER SOUND

(71) Applicant: Feel's Electronics Co., Ltd., Gyeonggi-do (KR)

(72) Inventor: Soon Ahn HWANG, Gyeonggi-do (KR)

(73) Assignee: Feel's Electronics Co., Ltd., Gyeonggi-do (KR)

(21) Appl. No.: 13/667,675

(22) Filed: Nov. 2, 2012

(30) Foreign Application Priority Data
Nov. 4, 2011 (KR) 10-2011-0114545

(51) Int. Cl. H04R 1/10

(52) U.S. Cl. CPC H04R 1/10
USPC 381/374

(57) ABSTRACT

An earphone minimizes the design elements for importing sound. It operates without a battery, is lightweight, harmonizes the design and ventilation of the paths for sound transmission, insulation and exhaust, and for augmenting and/or alleviating speaker vibration, and has its outer sound path and transmission path tilted. The earphone comprises a speaker, a body with a cover, a speaker sound path in the body to transmit sound toward the external auditory canal, and a worn portion including a cushion in a holder enclosing the speaker path worn in the external auditory canal. The body includes an outer sound path which imports sound. The worn portion includes a transmission path that receives the sound from the outer sound path and transmits it toward the external auditory canal. The outer sound path and transmission paths are insulated from sound from the speaker and the speaker sound path, respectively.

### RELATED APPLICATIONS

This application claims priority to Korean Patent Application No. 10-2011-0114545, filed on Nov. 4, 2011 in the Korean Intellectual Property Office, the entire disclosure of which is incorporated herein by reference.

### BACKGROUND OF THE INVENTION

1. Field of the Invention

The present invention relates to an earphone, and more specifically to an earphone importing outer sound in which the sound outside of the earphone, namely, outer sound, is imported into the inside of the earphone so as to be heard together with the original speaker sound of the earphone.

2. Description of the Related Art

In general, an earphone is an equipment which converts the electric signals received from an electronic device such as an amplifier, computer, smart phone, or the like into a sound using speaker and transmits it to the ears. The speaker generates vibration to form a sound, namely, a sound wave. The sound of a speaker, namely, speaker sound, reaches the external auditory canal of ears by way of a transmission path of sound, namely, a speaker sound path.

In such an earphone, the design and ventilation for path for sound transmission, sound insulation and sound exhaust, and the augmentation and alleviation of speaker vibration should be harmonized properly.

Conventionally in general, the outer sound outside of the earphone has been intentionally shielded so as to prevent it from coming into the earphone. This is done to have the speaker sound transmitted more clearly to the ear.

However, the side effects of shielding outer sound are very serious, such as occurrence of traffic accidents because the sound of a car horn is not heard due to walking with wearing an earphone on. Therefore, at least for an outer sound as large as that of a car horn, it is necessary to apply to the earphone outer sound recognizability to the extent that it can be easily recognizable with an earphone on.

As an example of a conventional earphone, Korean Patent Laid-Open Publication No. 10-2010-0024594 discloses an art of an earphone whereby outer sound is heard as the hearing aid mode is operated when a push switch 41 of a controller 4 connected to an earphone 1 is pressed.

However, the earphone of the above mentioned Patent Document describes an art in which a lot of elements are provided in a shell 3, which is a portion inserted into the external auditory canal, as illustrated in its FIG. 1. But in practice, the shape of the shell 3 is fitted so as to be suitable to the external auditory canal, so its internal space is also limited. Due to this, such a configuration is either impossible or extremely difficult in practice. Therefore, the art has a problem involved with realizability.

And, because the earphone of the above mentioned Patent Document includes a hearing aid assembly 2 for a hearing aid mode, electric power should be consumed not only when operating a speaker but also when importing outer sound.

Accordingly, a battery 24 must be provided therein. This entails an increase of weight, and either a charging problem or a battery exchanging problem.

Further, because the art of the earphone of the above mentioned Patent Document simply attempts a solution by electric circuits for importing outer sound, the earphone is not provided with an air path which exhausts outside an air pressure generated by compression when the shell is inserted into the external auditory canal, and does not disclose a rear side design for alleviation of speaker vibration. Thereby, the earphone employing the art induces a pain by air compression during insertion into external auditory canal, and creates a fear of inducing a noise or displeasure, because reverse vibration occurring on the speaker of the opposite side of the external auditory canal remains excessively.

### SUMMARY OF THE INVENTION

Accordingly, it is an object of the present invention to provide an earphone importing outer sound that is realizable in practice by minimizing the design elements for importing outer sound considering the limited internal space of the earphone.

Another object of the present invention is to provide an earphone importing outer sound that is lightweight and free of charging or exchanging a battery by making it operate sufficiently without a battery.

Yet another object of the present invention is to provide an earphone importing outer sound that is configured harmoniously by considering all of the design and ventilation of the path for sound transmission, sound insulation and sound exhaust, and augmentation and alleviation of speaker vibration together.

Furthermore, yet another object of the present invention is to provide an earphone importing outer sound in which the outer sound path is also tilted when the external auditory canal insert portion is tilted, even in the case of the structure in which the external auditory canal insert portion is tilted with respect to the earphone main body.

To achieve the above objects, there is provided an earphone importing outer sound including a body and a worn portion, the body including a speaker which generates speaker sound depending on electric signals and a cover enclosing the speaker, and the worn portion including a speaker sound path provided in the body to transmit the speaker sound toward the external auditory canal and a cushion that is provided in a holder enclosing the speaker sound path and is worn in the external auditory canal, the earphone importing outer sound characterized in that, the body includes at least one outer sound path which imports the outer sound outside of the body into the inside of the body; the worn portion includes transmission path which delivers the outer sound from the outer sound path toward the external auditory canal; and the outer sound path and the transmission path are insulated from sound from the speaker and the speaker sound path, respectively.

Here, the speaker may be installed so as to divide the internal space of the cover in two of an upper space and a lower space in the middle of the cover, and the cover enclosing the upper space may have at least one sound exhaust aperture which releases the vibration on the topside surface of the speaker to outside.

In addition, the speaker may be installed so as to divide the internal space of the cover in two of an upper space and a lower space in the middle of the cover, and the cover enclosing the lower space may have at least one air vent which releases the pressure of the outer sound path and the transmission path to outside.

Preferably, the worn portion is pivotally installed on the body, and when the worn portion pivots on the body, the transmission path pivots together with the worn portion.

Further, the cover may include an upper cover and a lower cover to form an appearance of the body, and the outer sound path may be formed on a flange exposed to outside between the upper cover and the lower cover.

According to the earphone importing outer sound of the present invention, the design elements for importing outer sound can be minimized considering the limited internal space of the earphone. Thus, it is possible to provide an earphone importing outer sound that is realizable in practice.

And it is possible to provide an earphone importing outer sound that is lightweight and does not require charging or exchanging a battery, since it can be operated sufficiently without a battery.

Further, it is possible to provide an earphone importing outer sound that is configured harmoniously by considering all of the design and ventilation of the path for sound transmission, sound insulation and sound exhaust, and augmentation and alleviation of speaker vibration together. Especially along with this, it is possible to provide an earphone importing outer sound in which the outer sound path is tilted as well when the external auditory canal insert portion is tilted, even in the case of the structure in which the external auditory canal insert portion is tilted with respect to the earphone main body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of an earphone importing outer sound according to an embodiment of the present invention;

FIG. 2 is a front view of the earphone importing outer sound according to an embodiment of the present invention;

FIG. 3 is a longitudinal sectional view of the earphone importing outer sound according to an embodiment of the present invention; and

FIG. 4 is a perspective view illustrating a construction having an outer sound importing structure employed in the earphone importing outer sound according to an embodiment of the present invention.

### EXPLANATION OF REFERENCE NUMERALS OF MAIN PARTS OF THE DRAWINGS

100: body,
110: upper cover, 111: sound exhaust aperture,
112: cord aperture, 113: upper hole,
120: lower cover,
121: air vent, 122: pivot seat portion,
130: upper holder,
131: sound exhaust aperture, 132: cord aperture,
133: flange, 134: outer sound path,
140: lower holder, 141: pivot seat portion,
150: speaker,
200: worn portion,
210: speaker sound path, 211: pivot portion,
220: inner holder,
221: pivot portion, 222: transmission path,
230: cushion holder, 231: pivot portion,
240: cushion,
300: cord portion

### DETAILED DESCRIPTION OF THE INVENTION

Hereinafter, an earphone importing outer sound of the present invention will be described in detail with reference to the accompanying drawings.

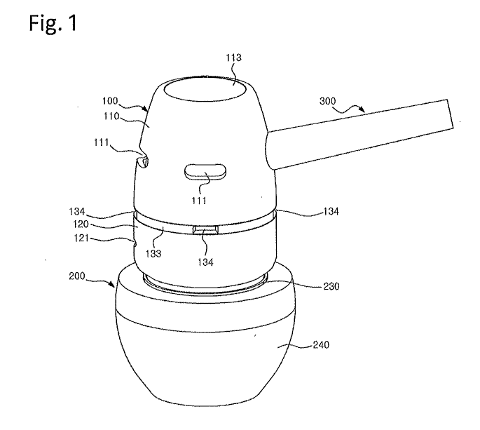

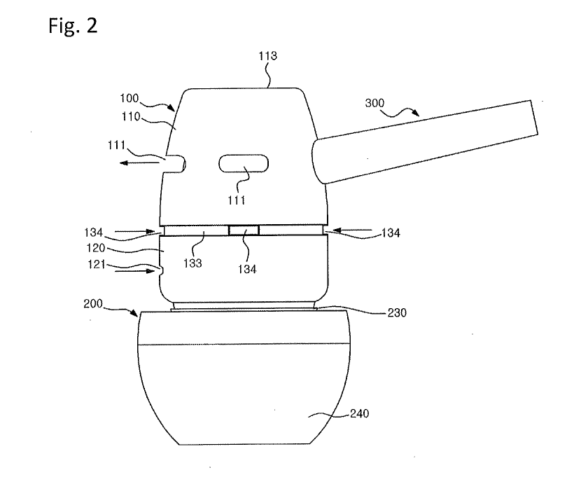

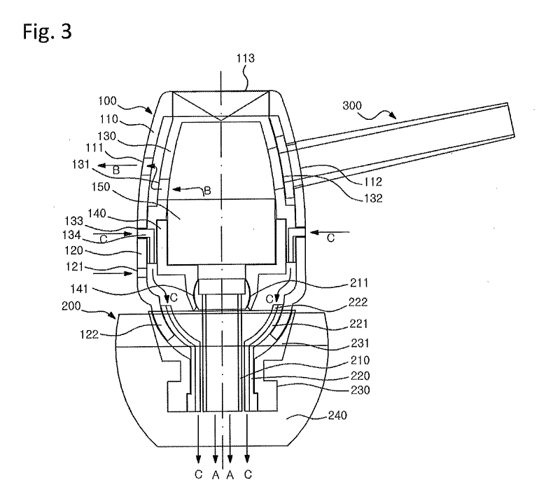

FIG. 1 is a perspective view of an earphone importing outer sound according to an embodiment of the present invention, FIG. 2 is a front view of the earphone importing outer sound according to an embodiment of the present invention, and FIG. 3 is a longitudinal sectional view of the earphone importing outer sound according to an embodiment of the present invention.

Basic Configuration

The earphone importing outer sound of the present invention includes a body 100 and a worn portion 200 arranged below the body 100.

The body 100 includes a speaker 150 installed therein and a cover.

The speaker 150 generates a speaker sound depending on electric signals transmitted from an electronic device (not shown). An electric cord for transmitting signals to the speaker 150 is connected to the speaker 150 through a cord portion 300.

The cover encloses the speaker 150. In the embodiment illustrated in FIG. 3, the cover is a concept including not only an upper cover 110 and a lower cover 120 but also an upper holder 130 and a lower holder 140. That is, in the embodiment illustrated in FIG. 3, the cover has a dual structure consisting of the cover and the holder, but the present invention is not particularly limited thereto. For example, a cover simply with a single structure (i.e. consisting of either a cover or a holder) can be employed in the present invention as well.

The worn portion 200 includes a speaker sound path 210 and a cushion 240.

The speaker sound path 210 provided in the lower portion of the body 100 is a path for transmitting a speaker sound A toward the external auditory canal of ear, that is, downward in the drawing.

A cushion 240 is provided in another holder that encloses the speaker sound path 210 to wear in the external auditory canal. Here, another holder is a concept including an inner holder 220 and a cushion holder 230 in the embodiment illustrated in FIG. 3. That is, in the embodiment illustrated in FIG. 3, this holder has a dual structure, but the present invention is not particularly limited thereto. For example, a holder simply with a single structure, and the case that the cushion 240 is mounted directly on the outer circumference of the speaker sound path 210 can be employed in the present invention as well.

Here, the present invention is characterized in that at least one outer sound path 134 is provided in the lower portion of the body 100 and at least one transmission path 222 is provided in the worn portion 200.

The outer sound path 134 is a path for importing the outer sound C outside of the body 100 into the inside of the body 100. The outer sound path 134 is formed in a portion of the body 100, and when the layout of the sound exhaust apertures 111 and 131 to be described later is considered, it is preferable to be formed on the side of the body 100. The outer sound C is transmitted to the transmission path 222 formed toward the external auditory canal (downward in the illustrated example) by way of the outer sound path 134. The body 100 also includes cord apertures 112 and 132 for inserting a cord and an upper hole 113.

The transmission path 222 is a path which receives the outer sound C from the outer sound path 134 and transmits it toward the external auditory canal (downward in the illustrated example). The outlet of the transmission path 222 is open toward the external auditory canal. Thus, the outer sound C is transmitted simultaneously to the external auditory canal together with the speaker sound A.

In addition, the outer sound path 134 and the transmission path 222 are insulated from sound from the speaker 150 and the speaker sound path 210, respectively. That is, the speaker sound A generated from the speaker 150 is transmitted toward the external auditory canal only through the speaker sound path 210. Meanwhile, the outer sound C imported from the aperture of the outer sound path 134 is transmitted toward the external auditory canal only through the outer sound path 134 and the transmission path 222. Accordingly, these sounds are not mixed in the middle. However, both of the aperture toward the external auditory canal of the speaker sound path 210 and the aperture toward the external auditory canal of the transmission path 222 are open toward the external auditory canal. Therefore, the speaker sound A and outer sound C are mixed and transmitted simultaneously to the external auditory canal.

Thus, a separate power source is not required, and even if there is no specially embedded electronic equipment or element, the outer sound C is transmitted to the external auditory canal together with the speaker sound A.

Sound Exhaust Aperture for Alleviation of Speaker Vibration

In the basic configuration as described above, the speaker 150 is installed so as to divide the internal space of the cover in two of upper space and lower space in the middle of the cover as illustrated in FIG. 3.

In addition, the cover enclosing the upper space may be configured so as to have at least one (three at 90 degree intervals in the illustrated example) sound exhaust apertures 111 and 131 that transmit the vibration from the upper surface of the speaker 150 outside.

The upper space is a space compartmented into the inside of the upper holder 130 and the upside face of the speaker 150. In this case, the sound exhaust apertures 111 and 131 are formed respectively on the upper cover 110 and the upper holder 130. By alternating their layout positions with each other, it is possible to alleviate the noise by the discharge of speaker vibration.

However, as described above, the upper cover 110 and the upper holder 130 may be unitized. In this case, the upper space becomes a space compartmented into the inside of the unitized cover and the upside face of the speaker 150. In this case, the sound exhaust aperture's 111 and 131 are formed as one unit.

Accordingly, when the speaker 150 vibrates to generate a sound wave, the effective vibration generated toward the external auditory canal (downward in the illustrated example) produces an effective sound wave to contribute to the speaker sound A to be generated clearly. The ineffective vibration generated opposite to the external auditory canal (upward in the illustrated example) is discharged out of the earphone cover smoothly so as not to impede the effective vibration.

Air Vent for Alleviation of the Air Pressure of the External Auditory Canal

Further, in the case that the speaker 150 is installed so as to divide the internal space of the cover in two of an upper space and a lower space in the middle of the cover, the cover that encloses the lower space may be configured so as to have at least one (one in the illustrated example) air vent 121 for releasing the pressure of the outer sound path 134 and the transmission path 222.

The lower space is a space compartmented by the interior of the lower cover 120 and the exterior of the lower holder 140 that encloses the lower side of the speaker 150, in FIG. 3 for example. And the air vent 121 is formed in the lower cover 120.

Although the lower cover 120 and the lower holder 140 can be unitized as described above, the lower space becomes, also in this case, a space compartmented by the interior of the portion corresponding to the lower cover 120 and the exterior of the portion corresponding to the lower holder 140 in the unitized cover. Further, the air vent 121 is also formed in the portion corresponding to the lower cover 120.

Thus, when the worn portion 200 of the earphone is inserted into the external auditory canal, the air pressure is released through the air vent 121, so it is possible to alleviate the pain from air pressure even if compressed air raises the pressure of the outer sound path 134 and the transmission path 222. Further, by providing such a structure of the air vent 121 in the outer sound path 134 and the transmission path 222 or a connecting path to these, it is possible to contribute greatly to making space for common use.

Pivot Structure Synchronized with the Worn Portion

Meanwhile, the worn portion 200 can be installed pivotally to the lower portion of the body 100. In the embodiment illustrated in FIG. 3, the inner holder 220 and the cushion holder 230 of the worn portion 200 are pivotally connected to the pivot seat portion 122 of the lower cover 120 of the body 100, and the speaker sound path 210 of the worn portion 200 is pivotally inserted in the pivot seat portion 141 of the lower holder 140 of the body 100.

In this case, when the worn portion 200 pivots on the body 100, it is preferable that the transmission path 222 be provided so as to pivot together with the worn portion 200. In the embodiment illustrated in FIG. 3, since the transmission path 222 is formed in the inner holder 220 of the worn portion 200, the transmission path 222 pivots together therewith when the inner holder 220 pivots on the body 100.

Thus, it is guaranteed that the outer sound C is transmitted to the external auditory canal without any particular hindrance even if the worn portion 200 pivots on the body 100 at any angle.

Outer Sound Path Formed on the Flange

A specific embodiment of the outer sound path and the transmission path will be described.

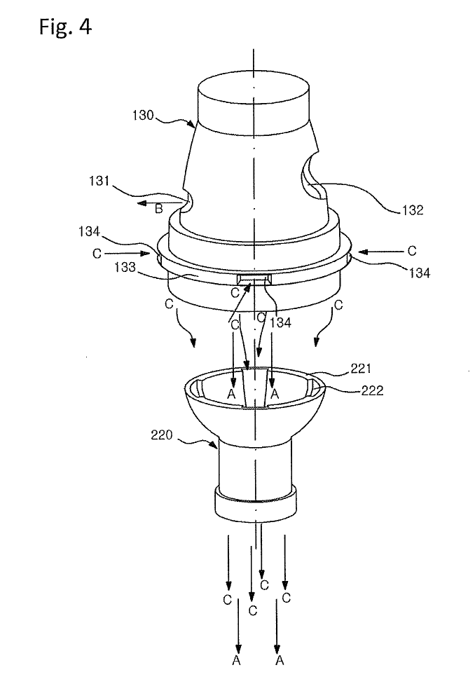

FIG. 4 is a perspective view illustrating a construction having an outer sound importing structure, namely, a structure having an outer sound path and a transmission path, which is provided in an embodiment of the earphone importing outer sound of the present invention.

In this case, the cover includes an upper cover 110 and a lower cover 120 to form the appearance of the body 100 as illustrated in FIG. 3. In addition, the outer sound path 134 can be configured so as to be formed on a flange 133 that is exposed outside between the upper cover 110 and the lower cover 120, as illustrated in FIGS. 3 and 4. That is, in the outer sound path 134, at least one (four in the illustrated example) outer sound inlet is opened on the outer surface of the flange 133, outer sound path inside (the groove shape in the illustrated example) extends toward the external auditory canal (downward in the illustrated example) along the shape of the flange 133, and outer sound outlet is opened at the end thereof (bottom end thereof in the illustrated example) toward the external auditory canal of the construction (the upper holder 130 in the illustrated example) formed integrally with the flange 133. Thus, the outer sound C is transmitted from the outer sound outlet to flow into the transmission path 222.

More specifically, the flange 133 and the outer sound path 134 may be formed on the upper holder 130 that supports the upper side of the speaker 150 inside of the upper cover 110, and the transmission path 222 may be formed in the inner holder 220 that mounts the worn portion 200 pivotally inside of the lower cover 120. However, the present invention is not particularly limited thereto. That is, although not shown in the drawings, the flange 133 and the outer sound path 134 may be formed on the lower holder 140 that encloses and supports the speaker 150 inside the lower cover 120.

Thus, if the outer sound path 134 is formed only on the flange 133, regardless of the shape of the upper cover 110 and the lower cover 120 that form the appearance of body 100 of the earphone, the outer sound C can be imported by the flange 133 exposed between them, so it is possible to make parts to be used exclusively for this purpose.

The present invention can be applied to an earphone, especially an earphone that can transmit and import outer sound to the external auditory canal.

While the present invention has been described with reference to the preferred embodiments, it will be understood by those skilled in the related art that various modifications and variations may be made therein without departing from the scope of the present invention as defined by the appended claims.

What is claimed is:

1. An earphone importing outer sound comprising a speaker which generates speaker sound depending on electric signals, a body which includes a cover enclosing the speaker, a speaker sound path provided in the body to transmit the speaker sound toward the external auditory canal, and a worn portion which includes a cushion that is provided in a holder enclosing the speaker path and is worn in the external auditory canal, the earphone importing outer sound characterized in that,
the body includes at least one outer sound path which imports the outer sound outside of the body into the inside of the body;
the worn portion includes at least one transmission path that receives the outer sound from the outer sound path and transmits it toward the external auditory canal; and
the outer sound path and the transmission path are insulated from sound from the speaker and the speaker sound path, respectively.

2. The earphone importing outer sound according to claim 1, wherein the speaker is installed so as to divide the internal space of the cover in two of an upper space and a lower space in the middle of the cover, and
the cover enclosing the upper space has at least one sound exhaust aperture which releases the vibration of the topside surface of the speaker to outside.

3. The earphone importing outer sound according to claim 1, wherein the speaker is installed so as to divide the internal space of the cover in two of an upper space and a lower space in the middle of the cover, and
the cover enclosing the lower space has at least one air vent which releases the pressure of the outer sound path and the transmission path to outside.

4. The earphone importing outer sound according to claim 1, wherein the worn portion is pivotally installed on the body, and
when the worn portion pivots on the body, the transmission path pivots together with the worn portion.

5. The earphone importing outer sound according to claim 1, wherein the cover includes an upper cover and a lower cover to form an appearance of the body, and
the outer sound path is formed on a flange exposed to outside between the upper cover and the lower cover.
